(19) United States
(12) Patent Application Publication
(10) Pub. No.: US 2002/0087468 A1
(43) Pub. Date: Jul. 4, 2002

(54) Electronic payment risk processing

(76) Inventors: Ravi Ganesan, Norcross, GA (US); Timothy Scott Renshaw, Cumming, GA (US); Peter Moenickheim, Dublin, OH (US); Paul J. Lyda, Delaware, OH (US); Cheryl Ward, Hillard, OH (US); Peter Kight, Alpharetta, GA (US)

Correspondence Address: Alfred A. Stadnicki, LALOS & KEEGAN, 1146 Nineteenth Street, N.W., Washington, DC, 20036-3703, US

(21) Appl. No.: 09/749,595

(22) Filed: Dec. 28, 2000

(51) Int. Cl. G06F 17/60

(52) U.S. Cl. 705/40

(57) ABSTRACT

A system and method for processing electronic payment requests. A request to make a payment for a network user is received over a network. The request includes information identifying the network user. All user identifiers associated with the network user are determined. Then, information about previous payments made for the network user is processed. This information about previous payments is based upon the determined identifiers. This processing determines if the request will be honored. A notification of the decision to honor or not to honor the request is then transmitted.

### TECHNICAL FIELD

The present invention relates generally to electronic commerce and more particularly to financial risk amelioration in providing payment services.

### BACKGROUND ART

It is well known that individuals, businesses and organizations keep funds in accounts maintained at financial institutions. These accounts include checking accounts and savings accounts. Entities keeping their funds in accounts are known as depositors. The practice of keeping funds in accounts at financial institutions provides many practical advantages. Among these are security and convenience. Large sums of money do not have be physically held by a depositor, funds can be exchanged between parties by the use of documents, such as checks, without the physical exchange of money, and movement of funds into and out of accounts can be easily tracked for efficient money management.

Conventionally, access to funds in an account is had in one of two ways. First, a depositor can make deposits and withdrawals in person. Secondly, a depositor can direct the financial institution to make payments on his behalf by the use of checks and other financial documents.

In an effort to make financial transactions more efficient and to provide further convenience to depositors, financial institutions have continually sought to improve existing services and to develop new services. For, instance, with the advent of the telephone, many financial institutions allowed depositors to orally direct, via telephone, a representative of a financial institution to perform some action for, or on behalf of, a depositor. Eventually, with the aid of computers, financial institutions began offering what is known as “telephone banking.” In telephone banking, a depositor telephones a computer associated with a financial institution to direct transactions. The computer typically offers one or more service options to the depositor via prerecorded messages. The depositor communicates with the computer by using a touch-tone key pad on the depositor's telephone, or by voice, whereby the computer is programmed to recognize verbal commands. This was the beginning of networked electronic banking, as the telephone system is a network. As computers became more common, financial institutions adopted systems whereby a depositor could communicate with, via a personal computer, a computer associated with the financial institution to direct transactions. The computers communicated via the telephone network. Other systems which evolved for electronic banking included banking via automated teller machines and kiosks.

Over the past several years an international network of networks known as the Internet has become increasingly popular. The Internet allows millions of users throughout the world to communicate with each other. To provide users with easier access to information available on the Internet, a World Wide Web has been established. The World Wide Web allows information to be organized, searched and presented on the Internet using hypertext. Thus, using the World Wide Web a user can submit a query for information and be linked electronically to information of interest which has been stored at Web locations on the Internet. Using hypertext, a user can also communicate information to other users of the Internet. Because of the use of hypertext, the information which can be queried and retrieved via the Internet includes not only textual information but also information in graphic, audio and video form. Web search engines and browsers have been developed to make searching and retrieval of information of interest on the Web a simple task. Hence, the Web has made it relatively easy for virtually anyone having access to a personal computer or other device connected to the Internet to communicate with others who are also connected to the network. This ease of use has resulted in an increase in the number of users utilizing the Internet.

With the proliferation of Internet users, numerous services are now provided over the Internet. One of the first such services to migrate to the Internet was electronic banking. Electronic banking allows banking customers to access their account information via a personal computer and execute banking transactions, e.g. the transfer of funds from a savings to a checking account, by simply linking to a bank server using the Internet to access account information and communicate transfer instructions. Today, in addition to utilizing a personal computer, customers can access account information and execute banking transactions via the Internet using Personal Digital Assistants, mobile telephones, and set-top boxes, among other devices capable of Internet access.

Electronic banking has advanced from this basic consumer-to-bank communication, either via telephone, or via computing device, to a consumer being able to electronically pay bills and make other payment types and fund transfers to others by communicating instructions, both via telephone and via the Internet, to a service provider possibly distinct from the financial institute maintaining deposited or credited funds of a pre-registered payer. The payments are then executed by the service provider. Funds from the payer's deposit or credit account, i.e. the payer's payment account, are debited by the service provider to cover the payment. The payment by the service provider to the payee can be made in any number of ways.

For example, the service provider may electronically transfer funds from the payer's banking account to a banking account belonging to the service provider. Then, electronically transfer funds from the service provider's banking account to the payee's banking account, or may prepare a paper draft or check drawn on the service provider's banking account and deliver it to the payee. The service provider may prepare an electronically printed paper draft drawn on the payer's banking account and payable to the payee and deliver it to the payee. Or, the service provider prepared paper draft may be payable to the service provider. If so, the service provider then either electronically transfers funds from the service provider account to the payee account. Or, the service provider may then prepare a paper draft or check drawn on the service provider's account and deliver it to the payee.

If the funds transferred to the payee are drawn from the service provider's banking account, funds from the payer's banking account are electronically or otherwise transferred to the service provider's banking account to cover the payment, typically before payment is made to the payee. Further, if the payment will be made from funds in the service provider's banking account, the payment will preferably be consolidated with payments being made to the same payee on behalf of other payers.

Accordingly, such electronic payment systems eliminate the need for a payer to write or print paper checks and then forward them by mail to the payee. This makes it easier and more efficient for the payer to make payments. Payees receiving consolidated payments no longer have to deal with checks from each payee and therefore can process payments more efficiently. The making of payments by the electronic or wire transfer of funds provides even further efficiencies in payment processing by payees, and it is well recognized that making payments electronically can significantly reduce the cost of processing payments for both the payer and the payee.

In conventional electronic payment systems, payment requests are processed before payment is released to reduce potential financial risk to the service provider. U.S. Pat. No. 5,383,113, to Kight et al., and assigned to the assignee of the present application, is directed to a bill payment system and method. Processing a bill payment request, as disclosed in Kight, can include a risk analysis of the payment request before the payment is executed. This risk analysis results in selection of a form of payment, discussed above, in which funds move, either electronically or by paper. The determination of form of payment is based upon such criteria as analyzing the payment request to determine if the amount of the payment request meets or exceeds a first determined amount and determining if the total amount of previous payment requests within a certain timeframe meets or exceeds a second determined amount. The first and second determined amounts are preferably different amounts. Thus, to protect against financial risk, the Kight patent discloses a technique which utilizes a decision between making payments in the less efficient paper form and the more efficient electronic form.

Accordingly, a need exists for a risk processing technique which does not rely upon, or result in, a determination between forms of payment.

A recent development on the Internet is a proliferation of Web sites, known as portals, which offer a myriad of services to network users. These services include electronic banking services. Portals generally do not themselves maintain the functionality to perform electronic banking. Rather, service providers, introduced above, execute the actual financial transactions directed by network users via one or more portals. A network user may have an on-line relationship with more than one portal. As a results, a network user may direct payments from a first portal and from a second portal. The first and the second portal may not have any relationship, but the same service provider may execute financial transactions for both portals. The network user with relationships with two or more portals may be known to each portal, and thus to the service provider, by a unique name for each portal, yet direct financial transaction from a singe banking account.

As discussed above, a service provider may perform a risk analysis based in part upon a history of payments executed on behalf of a network user. There currently is no technique whereby a service provider can perform a risk analysis based upon a network user's complete payment history when that network user directs payments through two or more portals, or via two or more unique names.

Accordingly, a need exists for a technique in which all prior payments can be included in a risk processing analysis.

### OBJECTIVES OF THE INVENTION

Accordingly, it is an objective of the present invention to provide a technique in which financial transactions are efficiently executed, yet a service provider is protected from financial risk.

It is also an objective of the present invention to provide a technique in which executed directives to make a payment on behalf of a network user, provided to a service provider from multiple sources, can be included in a risk processing analysis performed by the service provider.

Additional objects, advantages, novel features of the present invention will become apparent to those skilled in the art from this disclosure, including the following detailed description, as well as by practice of the invention. While the invention is described below with reference to preferred embodiment(s), it should be understood that the invention is not limited thereto. Those of ordinary skill in the art having access to the teachings herein will recognize additional implementations, modifications, and embodiments, as well as other fields of use, which are within the scope of the invention as disclosed and claimed herein and with respect to which the invention could be of significant utility.

### SUMMARY DISCLOSURE OF THE INVENTION

The present invention provides a method for processing electronic payment requests and a system for implementing the method. In particular, the present invention ameliorates financial risk in providing electronic payment services. The system includes at least one processor, a memory for storing data, and a communications port for transmitting and receiving information. The processor may be any type processor, such as a personal computer, high powered workstation, Internet server, or sophisticated mainframe computer. The memory may be any type of memory capable of storing data, including random access memory, floppy or hard magnetic disk, or optical disk. Data stored in the memory and data processed by the processor are exchanged between the processor and the memory. The data can include information associated with financial transactions, network users directing financial transactions, and operating instructions for controlling the operations of the processor. The communications port communicates with one or more networks configured to transmit electronic or optical data. The networks can include a public or private telephone network, the Internet, a private banking network, or any other type network.

The memory stores a plurality of user identifiers associated with a plurality of network users. A network user may be an individual, a business, or other organization. Each network user is associated with at least one, if not more than one, user identifier. This identifier identifies the user to the processor, as well as other network users. If a network user possesses more than one identifier, that user can identify himself to the processor, or other network users, using any of the identifiers. Each identifier associated with each network user is stored in the memory. This information may be stored in a specialized database, or in general memory. The memory also stores information associated with previously executed payments on behalf of the plurality of network users, the information associated with each previously executed payment including a user identifier. This information, also, may be stored in a specialized database or otherwise. The processor makes payments on behalf of network users. When requesting that a payment be made on behalf of a network user, the network user identifies himself using a unique identifier. A record of each payment executed by the processor is stored in the memory. Each record includes details about the payment, including the user identifier used in submitting the request.

The processor is configured to receive these payment requests via a network. The payment requests can be for payments of a bill, gift payments, purchase payments for goods and services purchased via the network, including goods and services purchased via an Internet auction, or any other type payment. The network is preferably the Internet, though it could be any network allowing network users to communicate. Additionally, the network may be a wireless network or a partially wireless network. A payment request is transmitted to the processor via the network and the processor receives the request via the communications port. The network user on whose behalf the payment may be made, a payer, may make the transmission to the processor, or another network user acting on behalf of the network user may make the transmission. This transmission may be made via a Web page, via an email communication, via a message set such as OFX, or another type of network communication, either real-time or not. When this transmission is a real-time transmission, the network user making the transmission can be informed in real time if the request is accepted for execution. The processor is also configured to identify all user identifiers associated with the payer.

In one especially preferred aspect of the invention, the processor processes the information associated with previously executed payments made on behalf of the payer to determine if the payment request will be accepted for execution. Using the identified user identifiers associated with the payer, the processor thus considers each payment executed on behalf of the payer irrespective of the user identifier the payer provided when making the previous payment requests.

After the processor determines whether or not to accept the payment request for execution, the processor informs the network user that transmitted the request of the decision. This includes either notifying that network user that the payment will be executed, or notifying that network user that the payment will not be executed. Preferably, this notification is a real-time notification to the payer, though it could be a non-real time notification. A real time communication is made while the user is in direct communication with the processor. Thus, the network user immediately knows if the payment will be made.

Beneficially, the processor can determine a total monetary value of previously executed payments in one or more time periods and determine if this total exceeds one or more threshold values. That is, the processor adds together each previous payment made on the network user's behalf within at least one time period to determine a total value of payments executed for that network user. If this total value is greater than a predetermined value, the payment will not be executed. Preferably, each period begins at the time the request is being processed by the processor and runs backwards. More than one time period may be considered. Thus, the determined total value for one period may be less than a predetermined value, but the total value for a second period may be greater than a predetermined value. In such a case, the payment would not be executed. Also, the processor can include the value of the present payment request in the total amount. In such a case, a period begins at the time the request is being processed. The periods and the predetermined values may be varied from standard periods and values based upon criteria. These criteria include the identity of the payer and relationships the payer maintains. Preferably, the processor first processes identity information associated with the payer to determine if the values and periods are to be varied from standard values and period. Also preferably, the results of this identity processing are the same no matter the user identifier a user uses to identify himself. And, if the identity of the payer does not alter the standard periods and values, then the processor processes information associated with a relationship maintained by the payer to determine if the periods and values are to be altered. If not, standard periods and values are utilized by the processor.

Also beneficially, the processor can determine the number of previously executed payments in one or more time periods, add to the number the present request, and determine if this total number of previously executed payments and the present request exceeds one or more values. That is, the processor determines the number of payments made on the network user's behalf in at least one time period, and adds to this the number one, to account for the present request. The result of this addition is known as a volume of payments. If this volume is greater than a predetermined threshold, volume, of payments, the payment will not be executed. As above, more than one period may be considered, and period and thresholds may be varied based upon the identity of the payer and relationships maintained by the payer

Advantageously, a user identifier may also be associated with a sponsor. A sponsor is an entity which provides services to network users, including the payment services performed by the processor. A sponsor may be a financial institution, an Internet portal, or a merchant, among other entities. The above-described time periods used in determining if a payment request will be executed can be varied based upon a sponsor associated with a user identifier included in the payment request being processed. Also, the above-described volume and amount thresholds may be varied based upon a sponsor.

In another especially preferred aspect of the present invention, when making a payment on behalf of a network user, the processor directs a debit from an account associated with a network user at a first time and directs a credit to a payee at a second time. The credit to the payee can be a draft or a check, or an electronic credit to an account associated with the payee. The first time is the beginning of a time period, and the second time is the end of the time period. The processor can vary the length of the time period, perhaps from a standard time period such as three days.

The length of the time period can be based upon one, all, or any combination of, the amount of the payment being made, the identity of the network user, an association maintained by the network user, or payments previously made on behalf of the network user.

In basing the time period on the payment amount, if the amount of the payment is above a first predetermined amount, the period may be lengthened. If the amount of the payment is below a second predetermined amount, the period may be shortened, or perhaps eliminated. There may be several predetermined amounts, each associated with a different time period. Or, there may be a range of payment amounts, each range associated with a different time period, such that payments within a given range are associated with the same time period.

The identity of the network user can include information identifying the creditworthiness of the network user. For less creditworthy network users, the period may be lengthened. For more creditworthy network users, they period may be shortened or done away with. The processor may determine the creditworthiness of the network user once, or each time the network user directs a payment to be made. This creditworthiness determination is preferably the same determination irrespective of the user identifier with which a network user chooses to identify himself.

When basing the time period on an association maintained by the network user, this association can include an association with a sponsor, discussed above. Thus, the time period can be varied based upon a sponsor associated with the network user. Different associations can result in different time periods.

When the determination of the time period is based upon payments previously executed on behalf of the network user, the period can be varied based upon an amount of payments previously made and/or a volume of payments previously made, as discussed above.

In determining the length of the time period, the processor may process the information associated with previously executed payments made on behalf of the network user for whom the present payment is being made, as discussed above, to make this determination.

Thus, the time period can be varied based upon a total amount of payments executed on behalf of the network user in one or more time periods, as discussed above. Also, the time period can be varied based upon a volume of payments executed on behalf of the network user in one or more time periods, also as discussed above. And, as above, the time periods in which the payments were executed, as well as the volume and amount thresholds, can be varied based upon a sponsor associated with the user identification included in the payment request.

Directing debits and credits may include communications to one or more financial institutions. These communications may be made via the Internet, or some other network. Directing debits and/or credits to accounts maintained at the financial institutions may also include directing debit authorizations whereby fund availability is verified and an amount of funds are reserved. Each account may be a credit account, deposit account, stored value account, or other type account. Beneficially, the payee may also be a network user.

Advantageously, the processing to determine if a payment request is to be accepted can be combined with the processing to determine the length of the time period between the debit to the network user's account and the credit to the payee's account, or can be performed separately. That is, only one or both of the processings may be utilized.

### BRIEF DESCRIPTION OF DRAWINGS

FIG. 1 depicts exemplary networks of the present invention and users of the networks.

FIG. 2A depicts the enclosed community in accordance with the present invention populated with registered users, sponsors, and a processing agent, and with unregistered users outside of the enclosed community.

FIG. 2B depicts the flow of communications between various ones of the registered users, unregistered users, sponsors, and the processing agent of FIG. 2A.

FIG. 3 is a flow chart showing the operations which are performed by the processing agent in performing SPAP risk analysis to determine if a payment directive is to be accepted for execution.

FIG. 4 is a flow chart showing the operations which are performed by the processing agent in performing APAP risk analysis to determine if a payment directive is to be accepted for execution.

FIG. 5 is a flow chart showing the operations which are performed by the processing agent in performing APVP risk analysis to determine if a payment directive is to be accepted for execution.

FIG. 6 is a flow chart showing the operations which are performed by the processing agent in performing SPAP risk analysis to determine a hold-period.

FIG. 7 is a flow chart showing the operations which are performed by the processing agent in performing APAP risk analysis to determine a hold-period.

FIG. 8 is a flow chart showing the operations which are performed by the processing agent in performing APVP risk analysis to determine a hold-period.

FIG. 9 depicts a computer suitable for use by a registered user to access the Internet in accordance with the invention.

FIG. 10 is an exemplary block diagram of components of the computer depicted in FIG. 9.

FIG. 11A depicts an Internet server suitable for use by the processing agent in accordance with the present invention.

FIG. 11B is an exemplary block diagram of components of the server depicted in FIG. 11A.

FIG. 12 depicts the communications between various registered users and the processing agent depicted in FIG. 2A to effect a payment in accordance with the present invention.

FIG. 13 is a flow chart showing the operations which are performed by the payer and processing agent to effect a payment in accordance with the present invention.

FIG. 14 is a simplified depiction of a database containing information about registered users.

FIG. 15 is a flow chart showing the operations which are performed by the processing agent in determining whether to utilize a hold-period.

### BEST MODE FOR CARRYING OUT THE INVENTION

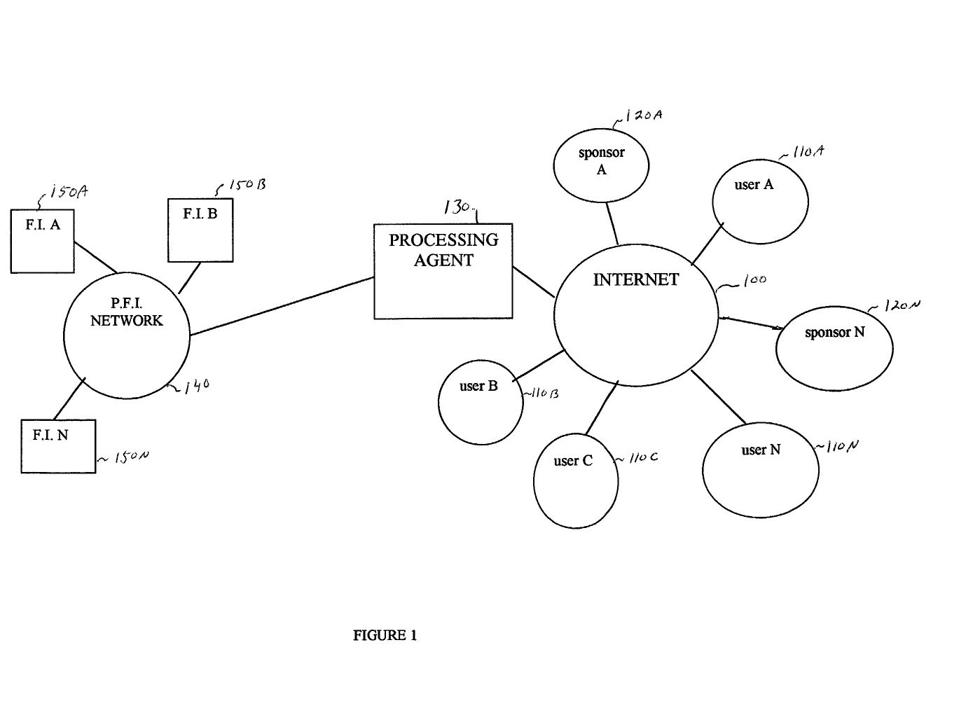

As shown in FIG. 1, network 100 interconnects multiple registered users 110A-110N, multiple sponsors 120A-120N, and a processing agent 130. The network 100 is shown to be the Internet, but could be virtually any type of network. Also shown is a network 140 interconnecting processing agent 130 and multiple financial institutes 150A-150N, each financial institute is associated with at least one of the registered users 110A-11ON, sponsors 120A-120N, or processing agent 130. The network 140 is shown to be a private financial institute network, such as the currently existing bank network over which it is quite common to electronically transfer funds between banks. Here again, the network 140 could be another type of network interconnecting the processing agent 130 to financial institutes 150A-150N. Network 140 could also be multiple networks.

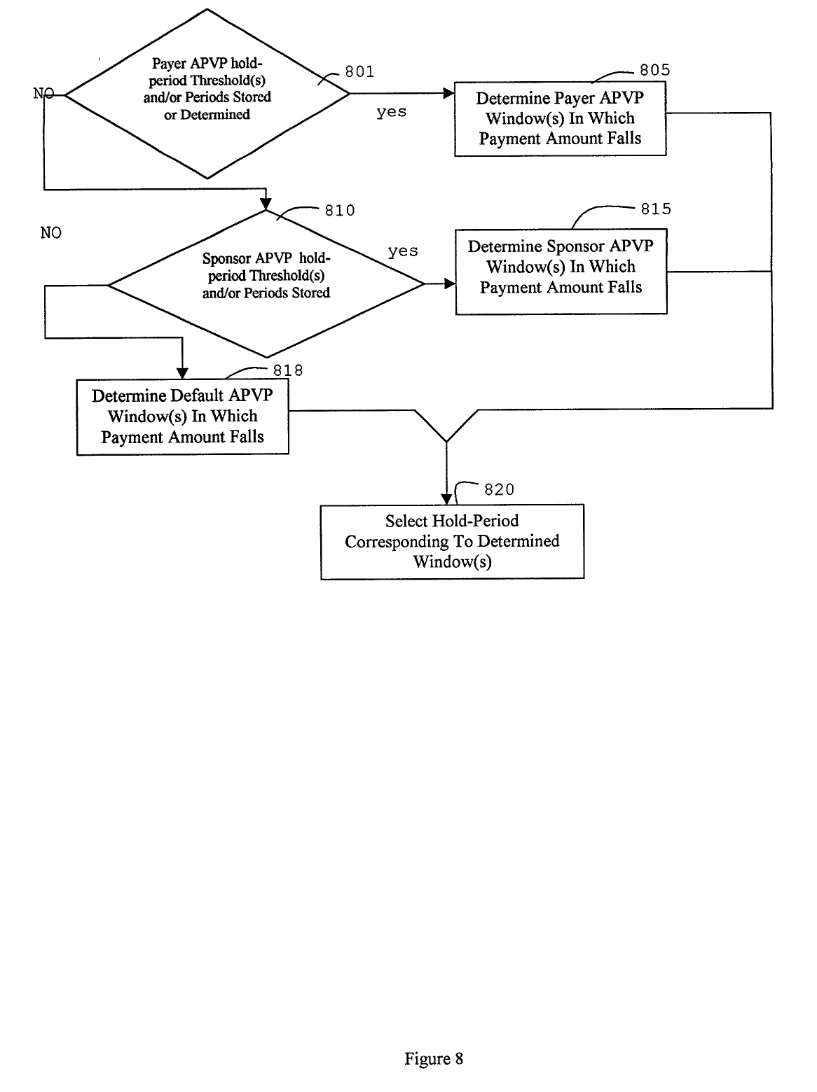

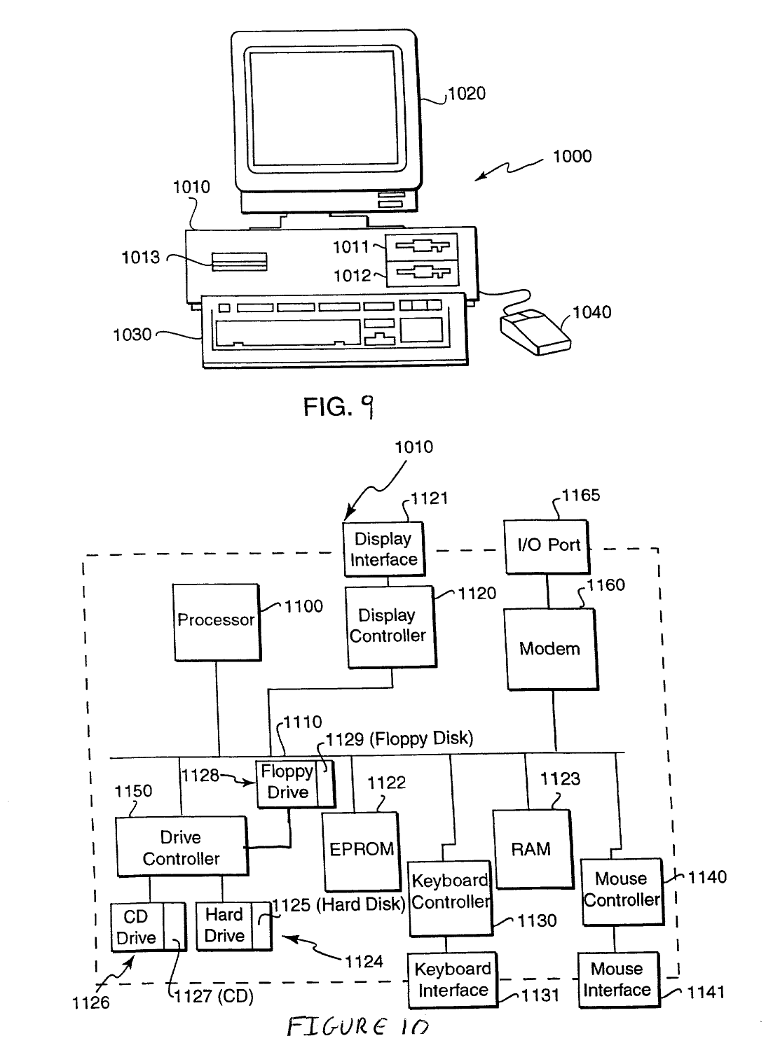

Each of the registered users 110A-110N is preferably represented on the network 100 by a computer of the type depicted in FIGS. 9 and 10, which will be described further below. However, it should be recognized that virtually any network device could be utilized so long as the device has sufficient processing and communication capabilities to function in the described manner. The term “network device” includes personal digital assistants (PDA's), telephones, including cellular and/or digital telephones, and set-top boxes, among other devices. It will also be understood that a network device may connect to a network via wireless communications.

FIGS. 9 and 10 depict an exemplary personal computer suitable for use by registered users 110A-110N to access the Internet 100 in the below-described invention. The computer is preferably a commercially available personal computer. It will be recognized that the computer configuration is exemplary in that other components (not shown) could be added or substituted for those depicted and certain of the depicted components could be eliminated if desired.

The computer functions in accordance with stored programming instructions which drive its operation. Preferably, the computer stores its unique programming instructions on an EPROM, or hard disk. It will be recognized that only routine programming is required to implement the instructions required to drive the computer to operate in accordance with the invention, as described below. Further, since the computer components and configuration are conventional, routine operations performed by depicted components will generally not be described, such operations being well understood in the art.

Referring to FIG. 9, the computer 1000 includes a main unit 1010 with slots 1011, 1012, and 1013, respectively provided for loading programming or data from a floppy disk, compact disk (CD), hard disk, and/or other storage means, onto the computer 1000. The computer 1000 also includes a keyboard 1030 and mouse 1040 which serve as user input devices. A display monitor 1020 is also provided to visually communicate information to the user.

As depicted in FIG. 10, the computer 1000 has a main processor 1100 which is interconnected via bus 1110 with various storage devices including EPROM 1122, RAM 1123, hard drive 1124, which has an associated hard disk 1125, CD drive 1126, which has an associated CD 1127, and floppy drive 1128, which has an associated floppy disk 1129. The memories, disks and CD all serve as storage media on which computer programming or data can be stored for access by the processor 1100. A drive controller 1150 controls the hard drive 1124, CD drive 1126 and floppy drive 1128. Also depicted in FIG. 10 is a display controller 1120 interconnected to display interface 1121, a keyboard controller 1130 interconnected to keyboard interface 1131, a mouse controller 1140 interconnected to mouse interface 1141 and a modem 1160 interconnected to I/O port 1165, all of which are connected to the bus 1110. The modem 1160 and interconnected I/O port 1165 are used to transmit and receive signals via the Internet 100 as described below. It will be understood that other components may be connected if desired to the bus 1110, including communications components other than a modem. By accessing the stored computer programming, the processor 1100 is driven to operate in accordance with the present invention.

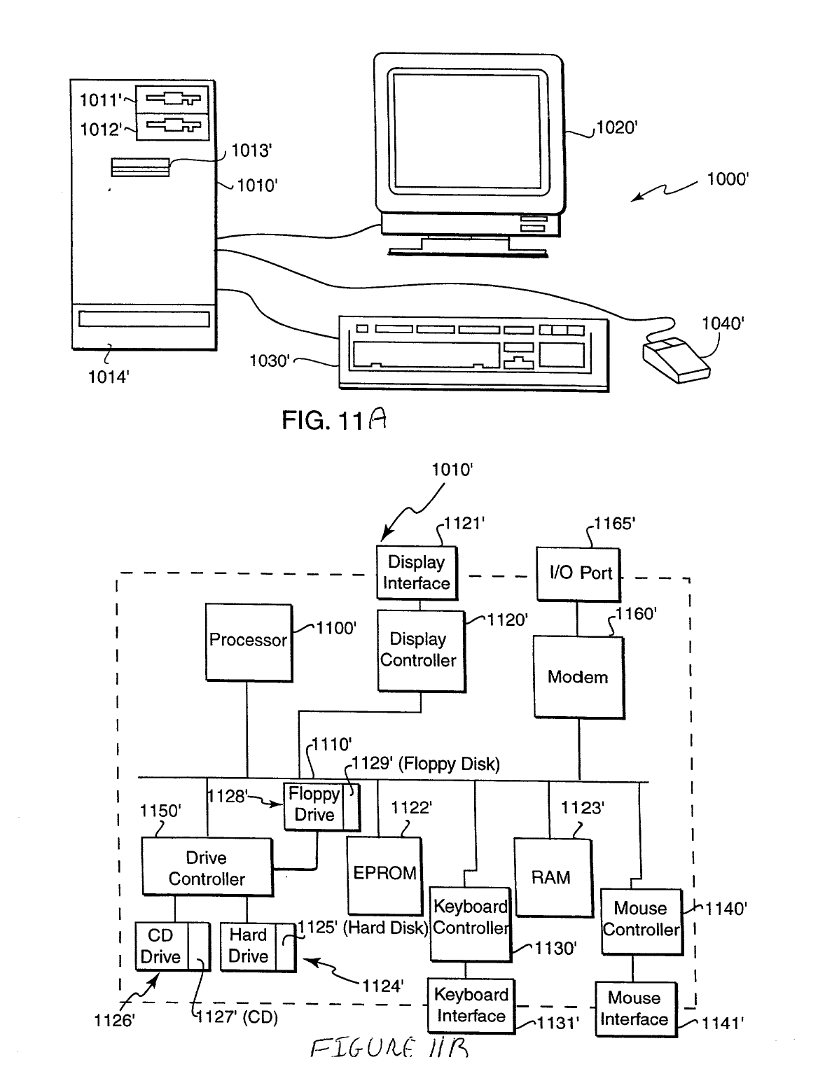

Each of the sponsors 120A-120N and the processing agent 130 is preferably represented on network 100, and for the processing agent 130 also on network 140, by an Internet server of the applicable type shown in FIGS. 11A and 11B, as will be described further below. However, here again, any network compatible device which is capable of functioning in the described manner could be substituted for the servers shown in FIGS. 11A and 11B.

FIGS. 11A and 11B depict an exemplary network server suitable for use by each of the sponsors 120A-120N and the processing agent 130 to access a network in the below-described invention. The server is preferably a commercially available high power, mini-computer or mainframe computer. Here again, it will be recognized that the server configuration is exemplary in that other components (not shown) could be added or substituted for those depicted and certain of the depicted components could be eliminated if desired.

The server's function as described below in accordance with stored programming instructions which drive their operation. Preferably, each server stores its unique programming instructions on an EPROM or hard disk. It will be recognized that only routine programming is required to implement the instructions required to drive the servers to operate in accordance with the invention, as described below. Further, since server components and configuration are conventional, routine operations performed by depicted components will generally not be described, such operations being well understood in the art.

Referring to FIG. 11A, the server 1000′ includes a main unit 1010′ with slots 1011′, 1012′, 1013′ and 1014′, respectively provided for loading programming or data from a floppy disk, CD, hard disk, and/or other storage means onto the server 1000′. The server 1000′ also includes a keyboard 1030′ and mouse 1040′, which serve as user input devices. A display monitor 1020′ is also provided to visually communicate information to the user.

As depicted in FIG. 11B, the server 1000′ has a main processor 1100′ which is interconnected via bus 1110′ with various storage devices including EPROM 1122′, RAM 1123′, hard drive 1124′, which has an associated hard disk 1125′, CD drive 1126′, which has an associated CD 1127′, and floppy drive 1128′, which has an associated floppy disk 1129′. The memories, disks and CD all serve as storage media on which computer programming or data can be stored for access by the processor 1100′.

For the processing agent 130, the stored data includes one or more databases containing information associated with registered users 120A-120N, sponsors 120A-120N, and transactions between various ones of the registered users 110A-110N. The memories associated with the processing agent 130 server hereafter will be collectively referred to as memory 1170.

A drive controller 1150′ controls the hard drive 1124′, CD drive 1126′ and floppy drive 1128′. Also depicted in FIG. 11B is a display controller 1120′ interconnected to display interface 1121′, a keyboard controller 1130′ interconnected to keyboard interface 1130′, a mouse controller 1140′ interconnected to mouse interface 1141′ and a modem 1160′ interconnected to I/O port 1165′, all of which are connected to the bus 1110′. The modem 1160′ and interconnected I/O port 1165′ are used to transmit and receive signals via the Internet 100 as described above. It will be understood that other components may be connected if desired to the bus 1110′, including communications components other than a modem. By accessing the stored computer programming, the processor 1100′ is driven to operate in accordance with the present invention.

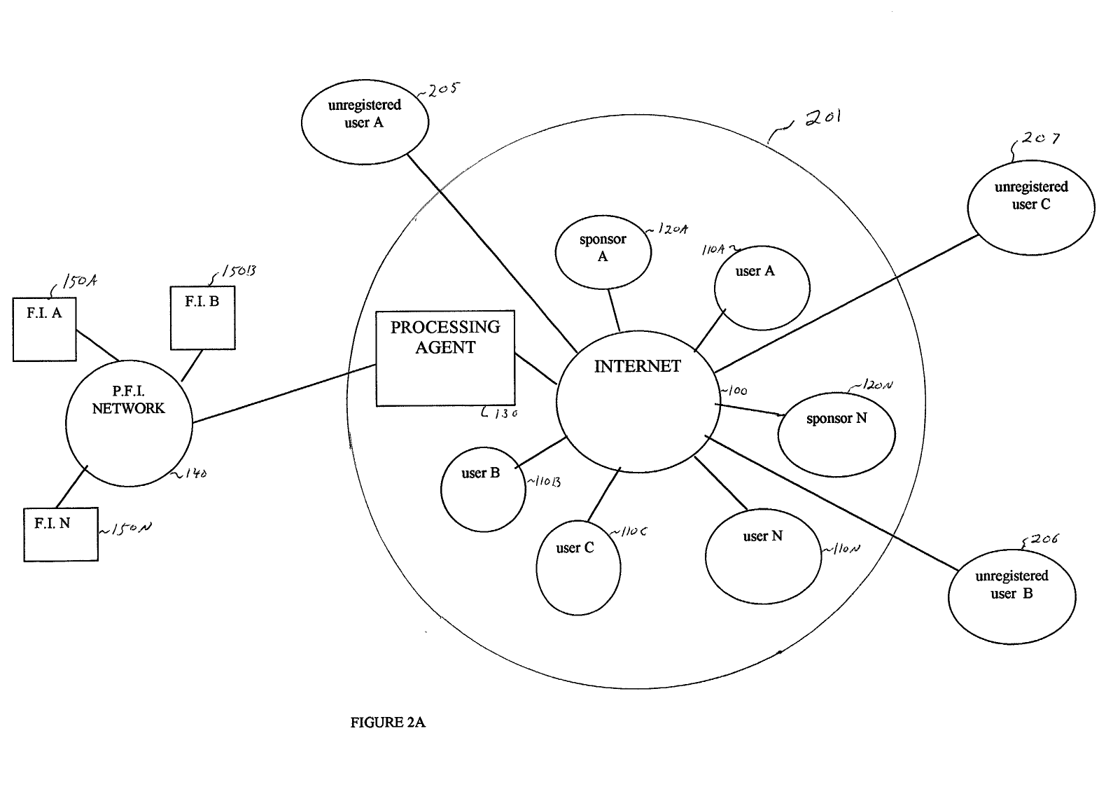

As shown in FIG. 2A, the registered users 110A-110N, sponsors 120A-120N, and processing agent 130 are part of an electronic enclosed community 201. Unregistered user A 205, unregistered user B 206, and unregistered user C 207 are not yet a part of the enclosed community 201, and as such cannot direct the processing agent 130 to perform financial services. Whereas, each of the registered users 110A-110N can direct the processing agent 130 to perform financial services. The financial institutions are not necessarily a part of the enclosed community 201. For purposes of the following discussion, the financial institutions are depicted as being separate from the enclosed community 201, however it should be understood that any of the financial institutions can be a registered user, a sponsor, or both.

Registered users, which may be individuals, businesses, or other organizations, interact via network 100, either directly with each other or through one or more of the sponsors 120A-120N. From these interactions, as well as others not made via network 100, arise financial transactions such as bill payments, sale payments, payments arising from Internet auctions, gift payments, and other types of funds transfers. The registered users exchange funds via the services of the processing agent 130, which is also a part of the enclosed community 201. These funds exchanges will collectively be referred to as payments, though they can arise from various types of transactions and relationships between registered users 110A-110N. The processing agent 130 directs execution of payments on behalf of the registered users 110A-110N. Registered users 110A-110N may also direct that payments be made to unregistered payees, whether or not an unregistered payee is a network user, as will be discussed below.

The flow of communications between various ones of the registered users 110A-110N, the sponsors 120A-120N, and the processing agent 130, as well as unregistered users A-C 205-207, are shown in FIG. 2B. Communications between registered user A 110A and the processing agent 130 are direct. That is, they do not flow through, or are directed by, a sponsor. Also, communications between the processing agent 130 and each of registered user 110B and unregistered user A 205 are direct. Communications between registered user C 110C and the processing agent 130, as well as between unregistered user B 206 and the processing agent 130, involve sponsor A 120A. Communications between registered user N 110N and the processing agent 130 may involve either sponsor A 120A or sponsor N 120N. Also, communications between unregistered user C 207 and the processing agent 130 may involve either sponsor A 120A or sponsor N 120N. When a sponsor is involved in the communication between a user and the processing agent 130, the sponsor may either facilitate real-time communication between the processing agent 130 and a user, or forward, in non-real time, communications between the processing agent 130 and a user.

Whether communications between a user, registered or unregistered, flow directly to the processing agent 130 or involve a sponsor, it will be understood that the communications preferably are transmitted via the Internet. A sponsor, as used herein, is a processor which offers content and services to network users, including the services of the processing agent 130.

Preferably, for transactions between registered users, payments are made in the form of an electronic debit from one registered user's demand deposit account (DDA) and an electronic credit to another registered user's DDA. Debits and credits can alternatively be made to accounts other than demand deposit accounts, such as credit accounts and brokerage accounts, among other types of accounts. Though, preferably, credits are made to a DDA. Also preferably, the electronic debits and electronic credits from and to demand deposit accounts are made via the automated clearinghouse bank network (ACH), though other networks and other electronic means may be used to affect the debits and credits. The processing agent 130 electronically effects the transfer of funds from one registered user's financial institution to the other registered user's financial institution while shielding both user's financial institution and account information from each registered user and providing the users with payment trustworthiness. For payments from a registered user to an unregistered user, the payment received by the unregistered user is preferably a check or draft drawn on an account belonging to the service provider, while funds are preferably obtained electronically from the registered user's account. To direct the processing agent 130 to perform financial services, a user need only register once to become a member of enclosed community 201. Once a user registers, the user can make payments to both registered users and unregistered payees, or receive payments from any other registered user. However, as will be further discussed below, a user may register more than once.

An unregistered user may register directly with the processing agent 130, or may register via one or more sponsors. A sponsor can present to users an option to become a member of enclosed community 201. For example, as depicted in FIG. 2B, while unregistered user A 205 may register directly with the processing agent 130, and unregistered user B 206 may register via sponsor A 120A, unregistered user C 207 may register via sponsor N 120N and/or via sponsor A 120A. For those unregistered users registering via a sponsor, an indicator of the sponsor from which the unregistered user is registering is stored in memory 1170. When registering, a user identifies one or more accounts from which the processing agent 130 debits and/or to which the processing agent 130 credits. It should be understood that whenever a registered user has identified more than one account, the registered user may identify the account from which funds are to be debited on a per transaction basis. Or, the registered user may identify a single account from which all debits are to be made. When receiving funds, the registered user may identify the account to which funds are to be credited on a per transaction basis. Or, the registered user may identify a single account to which all credits are to be made. Furthermore, a registered user may identify a single account from which all debits are to be made, and a different single account to which all credits are to be made. Also, at any time subsequent to registration, a registered user may add accounts, delete accounts, and otherwise change accounts. The processing agent 130 generates and stores in memory 1170 a unique user identifier and password associated with each registered user.

If a user registers via multiple sponsors, that user will have a unique identifier and password unique to each of the multiple registrations. Also, a user may register directly with the processing agent 130 multiple times, thus obtaining multiple unique identifiers. Or, a user may register directly with the processing agent 130 one or more times, as well as via one or more sponsors one or more times.

The processing agent 130 may make determinations relating to the creditworthiness of a registered user. These determinations may or may not be made during a registration process. They may be concurrent with registration, or they may follow. They can be made only once, or multiple times. The determinations may be made each time a registered user directs a financial transaction, or periodically. Use of creditworthiness determinations will be further discussed below.

In effecting a transfer of funds from a registered user's account, the processing agent 130 is the originator of these transactions and is therefore the recipient of, and responsible for, any uncollected debits. To protect against financial loss, the processing agent 130 can perform multiple types of risk analysis. The processing agent 130 may perform risk analysis based upon the identity of a registered user. This analysis can include determining a registered user's creditworthiness, based upon evaluating the credit history of the registered user, identification of DDA closures, and retrieval of bad check history relating to the registered user. The processing agent 130 may also perform risk analysis based upon individual transaction parameters. This determination can include evaluating the amount of a requested payment based upon one or more factors, including evaluating a registered user's past and present transactions on the basis of one or more volume and/or payment amount thresholds. The processing agent 130 may also perform risk analysis based upon relationships a registered user maintains.

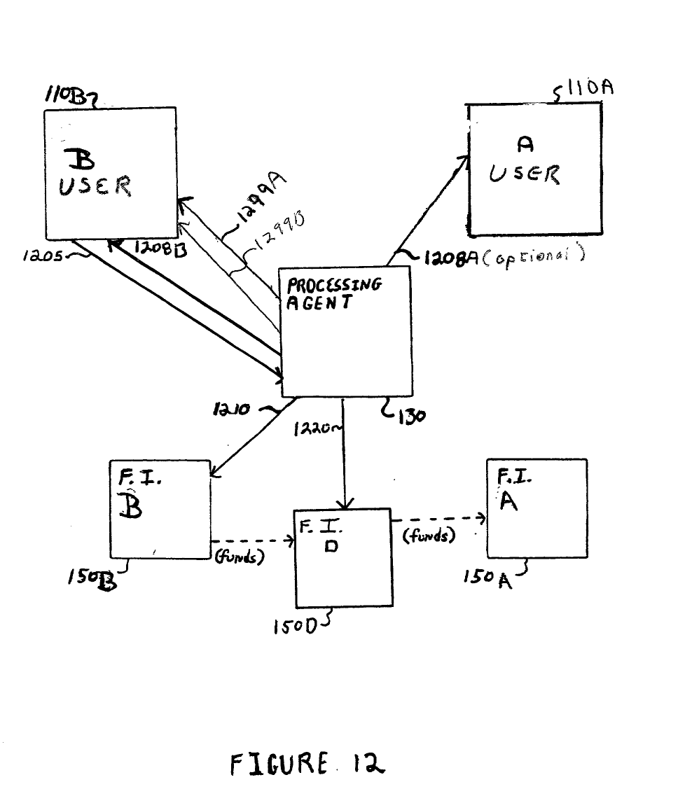

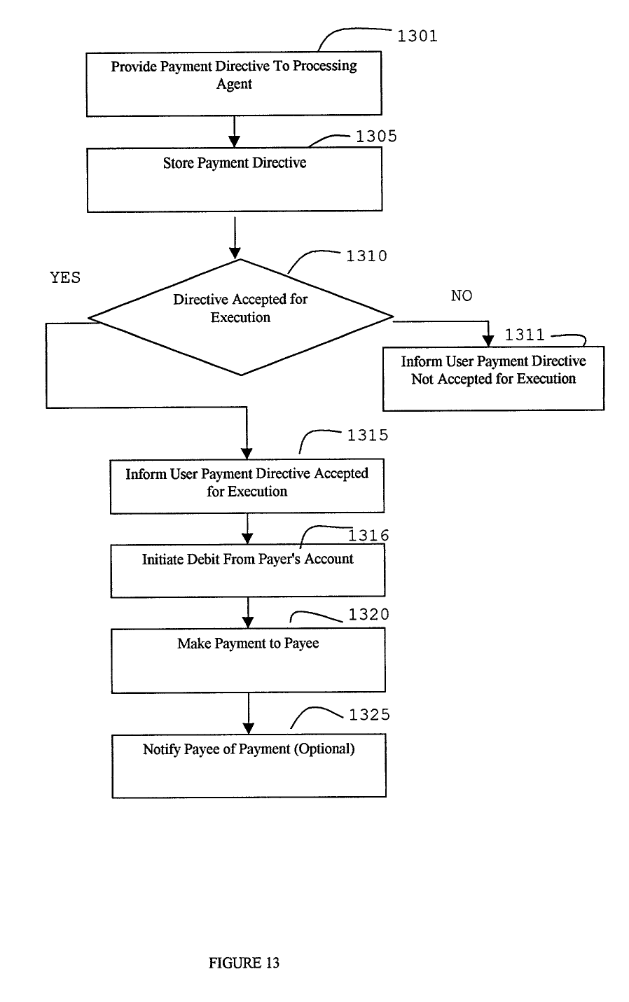

To aid in understanding the risk processing capabilities of the processing agent 130, FIGS. 12 and 13 show the communications for, and steps of, the processing agent 130 effecting a payment directive on behalf of registered user B 110B. Risk processing analysis may apply to any type financial transaction directed by any registered user. Also following are detailed examples of various risk processing capabilities of the processing agent 130. As these examples are merely illustrative, they should not be construed as being limited to any one type of financial transaction, or as being limited to use in any particular combination or order.

Registered user B 110B could be making payment of a bill, could be making a gift payment, or could be making an on-line purchase, among types of financial transactions. Registered user B 110B provides a payment directive to the processing agent 130, via communications 1205 and depicted at step 1301. The payment directive includes the amount of the payment and the unique user identifier associated with registered user B 110B. The payment directive also must include information identifying a payee, in this example registered user A 110A, though the payee could be an unregistered user, or may not be a network user at all. This information can be the unique identifier of the payee, if known by registered user B 110B, an email address associated with the payee, or the payee's name, among identifying information. Optionally, payment information can include a future date upon which payment is to be made. As depicted in FIG. 12, communication 1205 is a direct communication, though it should be understood that the communication could involve a sponsor. Also, this communication is preferably a real-time communication, though it could be a non-real-time communication.

Irrespective of how processing agent 130 receives the payment directive, processing agent 130 stores the payment directive in memory 1170, step 1305. To ameliorate the financial risk processing agent 130 is subject to, the processing agent 130 analyzes the payment directive, preferably in real time, and determines if the transaction will be accepted for execution, step 1310. If the payment directive is accepted for execution , the registered user may be informed, via communication 1299B and preferably in real-time, that the payment directive is accepted for execution, step 1315. If not, the registered user may be informed, via communication 1299A, and preferably in real time, that the payment directive is declined for execution, step 1311.

As introduced above, risk processing may be based upon both past and present transactions as well as the identity of the user directing the transaction and a relationship maintained by the registered user. The processing agent 130 is capable of performing multiple types of risk processing to determine if the payment request will be accepted for execution.

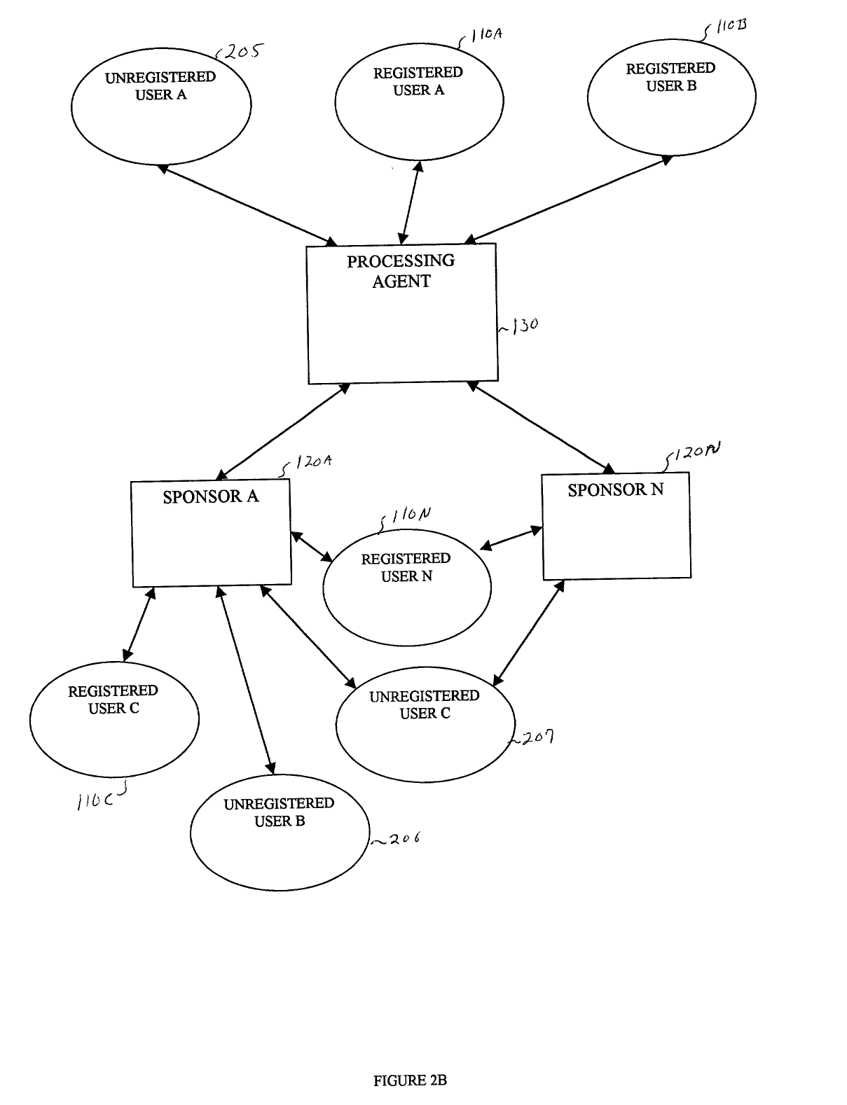

A first type of risk processing is based upon the amount of the payment directed, and is known as single payment amount processing (SPAP). The processing agent 130 may set a SPAP threshold such that payment requests at or above a certain amount will not be accepted for execution. This SPAP risk analysis is depicted in FIG. 3.

As shown in steps 301-318, the processing agent selects a SPAP threshold. The processing agent 130 stores a default system SPAP threshold to which all payment requests may be compared. This default SPAP threshold is used by the processing agent 130 unless other SPAP thresholds are present. At step 301, the processing agent 130 determines if a payer SPAP threshold is stored in memory 1170 associated with the registered user. This threshold is set dependent upon the identity of the registered user making payment. The creditworthiness determinations, introduced above, may used to set the payer SPAP threshold. The payer SPAP threshold may be higher or lower than the default SPAP threshold. When stored in memory 1170, payer SPAP thresholds are predetermined. Alternatively, in step 301, a payer SPAP threshold may be determined for each transaction based upon information associated with the payment directive. This may include a creditworthiness determination about the registered user. If a payer SPAP threshold is predetermined, or is determined per transaction, that payer SPAP threshold is selected, step 305. Thereinafter, operations continue with step 320.

If no payer SPAP threshold is stored or determined, the processing agent 130 next determines if a sponsor SPAP threshold is to be utilized, step 310. As discussed above, a user may register via a sponsor. An indication of this is stored in memory 1170 associated with the user's unique identifier. The processing agent 130 accesses memory 1170 and determines if the unique identifier provided by the registered user in the payment directive is associated with a sponsor, and if so, with which sponsor. The processing agent 130 then determines if a sponsor SPAP threshold is associated with the sponsor. If the unique identifier is associated with a sponsor, and a SPAP threshold is associated with that sponsor, at step 315, that sponsor SPAP threshold is selected. Operations thereinafter continue with step 320. If the unique identifier is not associated with a sponsor, or if an identified sponsor is not associated with a sponsor SPAP threshold, at step 318, the processing agent 130 selects the default SPAP threshold. Then, operations continue with step 320.

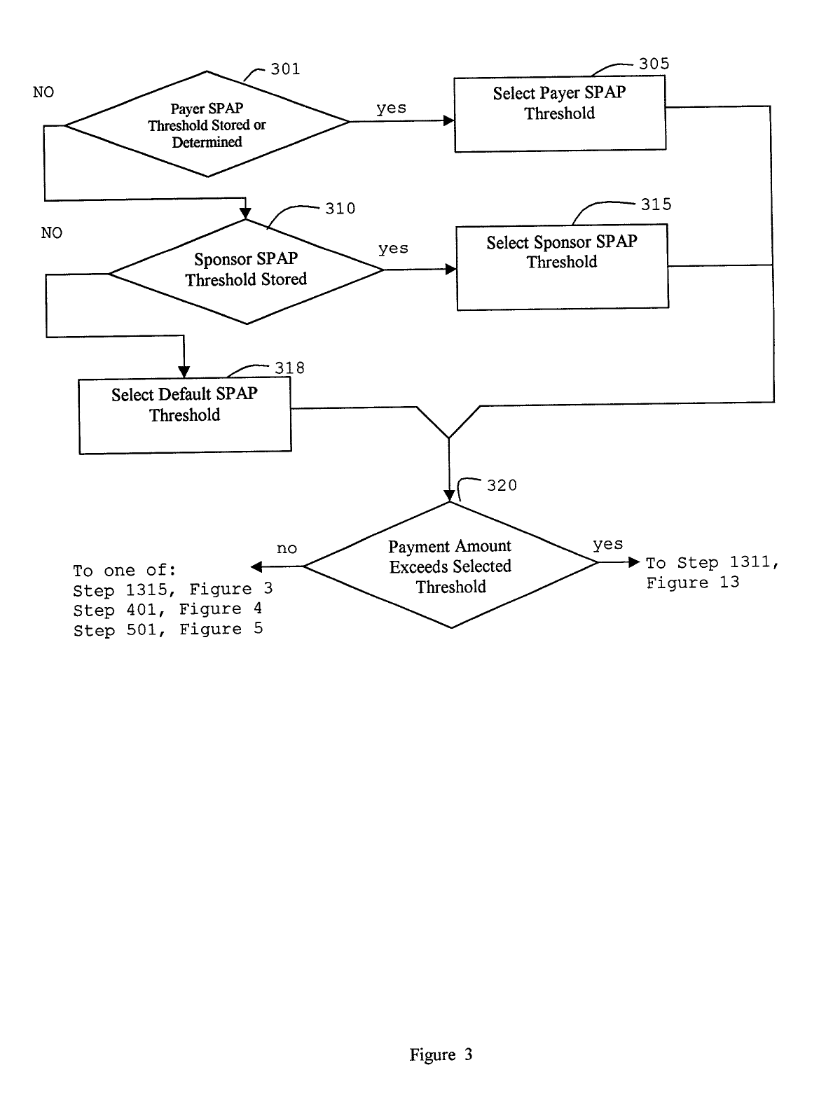

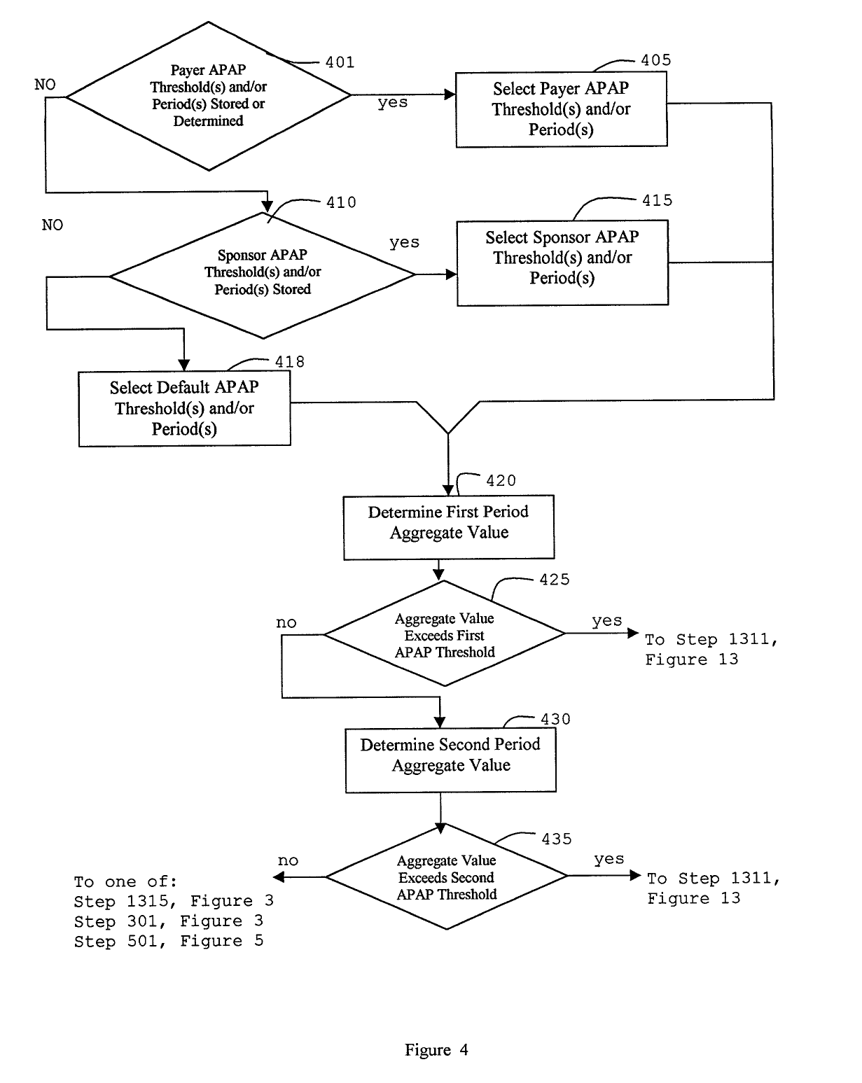

The processing agent 130 determines if the payment amount contained in the payment directive meets or exceeds the selected SPAP threshold, step 320. If so, the registered user directing payment is informed, preferably in real time, that the payment cannot be executed, as discussed above and depicted in FIG. 13, step 1311. If not, operations may continue with step 1315 of FIG. 13. Or, additional risk processing analysis to determine if the payment directive is to be accepted for execution may be performed. In such a case, operations may continue with either step 401 of FIG. 4 or step 501 of FIG. 5. It should be understood that SPAP risk analysis, as well as the processing discussed below, is not limited to payments in United States dollars. The processing agent 130 is capable of processing payment requests in any currency.

A second type of risk analysis is based upon the total monetary value of payments executed for the registered user within one or more time periods, preferably in combination with the value of the payment request contained in the payment directive being processed, and is known as aggregate payment amount processing (APAP). In APAP risk analysis, the monetary value of executed payments, preferably in combination with the monetary value of the present payment directive, within a time period is compared to an APAP threshold. Further, APAP risk analysis may include multiple time periods, each time period compared to a different APAP threshold.

As in SPAP risk analysis, the APAP threshold(s) may be set dependent upon the payer making the payment, may be set dependent upon a sponsor associated with that individual, or may be default thresholds. And, the period(s) associated with the threshold(s) may also be altered dependent upon the same factors. Furthermore, a threshold may be alternated from a default threshold, while an associated period is not, and vice versa. FIG. 4 depicts APAP risk analysis. As in step 301, at step 401, the processing agent 130 determines if one or more payer APAP thresholds and/or payer APAP periods preexist in memory 1170, or alternatively, determines payer APAP threshold(s) and/or payer APAP periods(s) for the particular transaction. If payer APAP criteria is stored or determined, at step 405, the payer APAP threshold(s) and/or period(s) are selected. Operations continue with step 420.

If not, at step 410, the processing agent 130 determines if one or more sponsor APAP thresholds and/or sponsor APAP periods are to be utilized. This determination will be understood by reference to the above-discussed determination of the sponsor SPAP threshold(s) and/or period(s). If sponsor APAP criteria are to be utilized, at step 415, the sponsor APAP threshold(s) and/or sponsor APAP periods(s) is/are selected and operations continue with step 420. If not, at step 418, the default threshold(s) is/are selected and then operations continue with step 420.

As depicted in FIG. 4, and described herein, two APAP time periods have been selected for analysis, but it should be understood that one APAP time period may be selected, or more than two APAP time periods may be selected. In this example, the first APAP time period is the 24 hour period preceding and including the time the present payment request is received and the first APAP threshold amount is $100. And, the second APAP time period in this example is the 168 hour period preceding and including the time the present payment request is received and the second APAP threshold is $1000. It should be understood that these time periods and thresholds may be any time periods and any thresholds. And, an APAP time period may not include the time the payment directive being processed is received. In such a case, the value of the payment requested in the payment directive is not utilized in the APAP processing. This also applies to APVP processing, to be discussed below.

At step 420, the processing agent determines the aggregate monetary value of the payments executed by the processing agent 130 for registered user B 110B, within the 24 hour period, in combination with the monetary value of the present payment request being processed. Information associated with each payment executed by the processing agent 130, including the registered user for whom the payment was executed and the payment amount, is stored in memory 1170. At step 425, the processing agent 130 determines if this aggregate value meets or exceeds $100. If so, the processing agent 130 informs the registered user that the payment cannot be executed, as described above and shown in step 1311 of FIG. 3. If not, the processing agent 130 determines, at step 430, the aggregate value of the payments executed by the processing agent 130 for registered user B 110B, within the 168 hour period, in combination with the value of the present payment request being processed. Then, at step 435, the processing agent determines if this aggregate value meets or exceeds $1000. If this aggregate 168 hour amount meets or exceeds $1000, registered user B 110B will be informed, in step 1311 of FIG. 13, that the payment cannot be executed. If the aggregate amount does not exceed this second threshold, operations may continue with step 1315 of FIG. 13. Or, additional risk processing analysis to determine if the payment directive is to be accepted for execution may be performed. In such a case, operations may continue with either step 301 of FIG. 3 or step 501 of FIG. 5.

A third type of risk processing which may be performed by the processing agent 130 is based upon the volume of payments executed for a registered user in one or more given time periods, and is known as aggregate payment volume processing (APVP). In the example of FIG. 5, two periods and thresholds are utilized. A first APVP threshold is set such that the aggregate number of payments executed within a first APVP time period, and alternately including the present payment directive, must not meet or exceed the first APVP threshold. And, a second APVP threshold is set such that the aggregate number of payments executed within a second APVP time period, and alternatively including the present directive, must not meet the second APVP threshold. As in APAP risk analysis, single or multiple periods may be selected, and periods and/or thresholds may be set based upon the payer or a sponsor. If payer or sponsor periods and/or thresholds are not utilized, default periods and/or thresholds are utilized in APVP risk analysis.

At step 501, the processing agent 130 either determines if one or more payer APVP thresholds and/or periods are stored in memory 1170, or processes information associated with the payment directive to determine one or more payer APVP thresholds and/or periods unique to this transaction. If the processing agent 130 determines that payer APVP criteria is stored, or determines criteria, at step 505 the payer APVP criteria are selected. Thereinafter, operations continue with step 520.

If no payer APVP criteria is stored or determined, at step 510 the processing agent determines is sponsor APVP criteria is to be utilized. If so, at step 515 sponsor APVP criteria is selected. If not, at step 518, default APVP criteria are selected. Step 520 follows both steps 515 and step 518.

In this example, the first APVP time period is the 48 hour period preceding and including the time the present payment request is received and the first APVP threshold is 15 payments. And, the second APVP time period is the 64 hour period preceding and including the time the present payment request is received and the second APVP threshold is 25 payments.

At step 520, the processing agent 130 determines the aggregate number of payments executed by the processing agent 130 for registered user B 110B within the 48 hour period, optionally including the present payment directive. Then, at step 525, the processing agent 130 determines if this aggregate number meets or exceeds the first APVP threshold of 15 payments. If so, as above, the registered user is informed that the payment cannot be executed, step 1311 of FIG. 13. If not, the processing agent 130 then determines the aggregate number of payments executed by the processing agent 130 for registered user B 110B within the 64 hour period, optionally including the present payment directive, step 530. The processing agent 130 then determines if this aggregate number meets or exceeds the second APVP threshold of 25 payments, step 535. If so, the registered user will be informed that the payment cannot be executed at step 1311 of FIG. 13. If this aggregate amount does not exceed this second APVP threshold, processing can continue with any of step 1315 of FIG. 13, step 301 of FIG. 3, or step 401 of FIG. 4.

The SPAP, APAP, and APVP risk analyses may be utilized individually, in any combination, in any order, or not at all, by the processing agent 130. If a payment request is rejected, based upon any of the above-described risk processing, the processing agent 130 may, in communication 1299A and step 1311, inform the registered user of the reason for the rejection. Furthermore, when multiple risk analysis is performed, if the payment directive is rejected under any one of the SPAP, APAP, and APVP risk analyses, the payment directive is not accepted for execution.

As discussed above, a registered user may register more than once. Thus, a registered user may direct payments using more than one unique identifier. That is, a single payer may include any one of multiple unique identifiers in a payment directive. The risk processing described above also protects the processing agent 130 in such a situation, as the memory 1170 also contains an indication of any association between two or more unique identifiers. That is, if a user registers multiple times using partial or complete like identifying information, an indication is stored in the memory 1170 of this association. This association can include two or more unique identifiers associated with the same email address, address, phone number, social security number, driver license number, and/or account information, among other identifying information which may be voluntarily provided by a registered user or required by the processing agent 130 for registration. The processing agent 130 associates each unique identifier belonging to the same registered user. Thus, whenever a registered user submits a payment directive, not only may the processing agent 130 perform the above-described risk analysis based upon the unique identifier contained in the payment directive, but the processing agent 130 may also include payment information in the risk analysis directed by the same registered user using other unique identifiers. Furthermore, when risk analysis criteria, such as thresholds, and periods, is based upon the payer's identity, the same criteria is utilized for a payer irrespective of the unique identifier contained in the payment directive. However, if sponsor criteria are utilized, sponsor criteria could differ according to the unique identifier contained in the payment directive, as each unique identifier may be associated with a different sponsor. Thus, a payment directive may be accepted for execution when submitted under a first unique identifier associated with a first sponsor, while the same payment directive may not be accepted for execution when submitted under a second unique identifier associated with a second sponsor.

Once the payment is accepted for execution, the processing agent 130 debits, or at a future date if so directed, via communication 1210 and depicted at step 1316, the account associated with the registered user B 110B. A corresponding credit is directed to an account associated with processing agent 130. FIG. 12 shows the account associated with registered user B 110B as being maintained at financial institution 150B. And, as shown in FIG. 12, the account associated with processing agent 130 is maintained at financial institution 150D. As should be understood, the account, preferably a DDA, associated with processing agent 130 may be maintained at any financial institution, preferably one capable of electronic transfers.

To further ameliorate the financial risk processing agent 130 is subject to, a payment to the payee, in this example, registered user A 110A, may not be effected for a period of time after the debit from the account associated with purchaser B 110B is initiated. This period is known as a hold-period. When the hold-period has elapsed, preferably three days, though it could be a shorter period or a longer period depending upon additional risk processing to be discussed below, and the debit has not been returned uncollected, the processing agent 130 makes payment to the payee, step 1320. By default, the processing agent 130 utilizes the hold-period, and the default period is three days. In this example, as the payee is registered, the processing agent 130 preferably electronically debits, via communication 1220, the account associated with the processing agent 130. This electronic debit results in a corresponding electronic credit to the account associated with the payee, registered user A 110A maintained at financial institution 150A. If the payee were an unregistered payee, the payment would preferably be made by either a check or a draft drawn on the processing agent's 130 account.

Since the payee in this example is registered, processing agent 130 may optionally inform registered user A 110A that new funds are available via communication 1208A and at step 1325. This preferably is done via e-mail. This notification can be executed once the debit to the payer's account has been initiated, once the predetermined period has lapsed, or once funds have actually been obtained from the payer's account.

Optionally, the operations depicted in steps 1320 and 1325 can be executed immediately after processing agent 130 receives a corresponding credit to the debit from the account associated with the payer, yet before the predetermined period has elapsed.

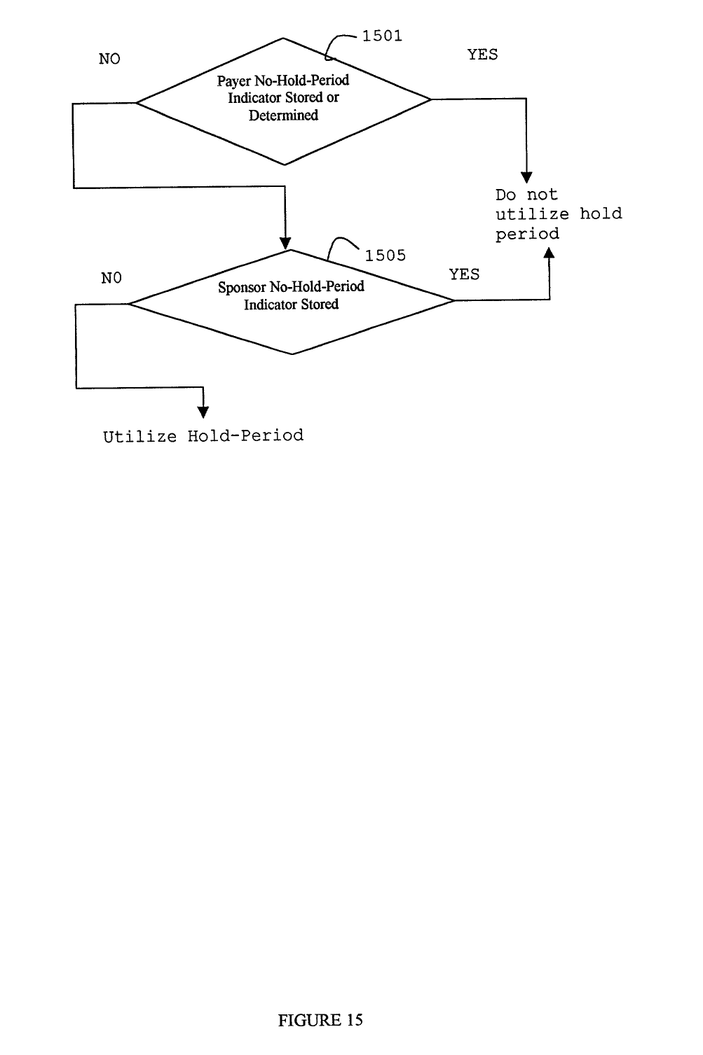

As indicated above, by default the processing agent 130 utilizes a hold-period. However, a hold-period may not be utilized. As depicted in FIG. 15, the processing agent 130 may make a determination whether or not to utilize a hold-period.

At step 1501, the processing agent accesses memory 1170 and determines if a no-hold-period indicator is stored associated with the registered user's unique identifier. A no-hold-period indicator may be generated based upon the registered user's creditworthiness. Alternatively, at step 1501, the processing agent 130 may determine, on a per-transaction basis, not to utilize the hold-period. This too may be based upon the registered user's creditworthiness. If a no-hold-period indicator is not stored in memory, or not determined, processing continues with step 1505. In this step, the processing agent 130 determines if a no-hold-period indicator is associated with a sponsor associated with the registered user, as will be understood from the discussion above of sponsor APAP and APVP risk analysis. If a no-hold-period indicator is determined to be stored in either of steps 1501 or 1505, or if in step 1501 the processing agent 130 determines not to utilize a hold period for this transaction, the hold-period is not utilized and payment to the payee may be made immediately, upon the determination not to utilize the hold-period.

When a hold-period is to be utilized, processing of the transmitted payment directive can include making determinations, similar to the risk analysis discussed above, to vary the hold-period between the debit from a registered payer's account and making payment to a payee. The hold-period can be changed from the default period, or perhaps done away with altogether, based on SPAP, APAP, and APVP risk analyses. One or any combination of these may be utilized. A hold-period may be determined at any time up to and including making the initial debit from the payer's account.

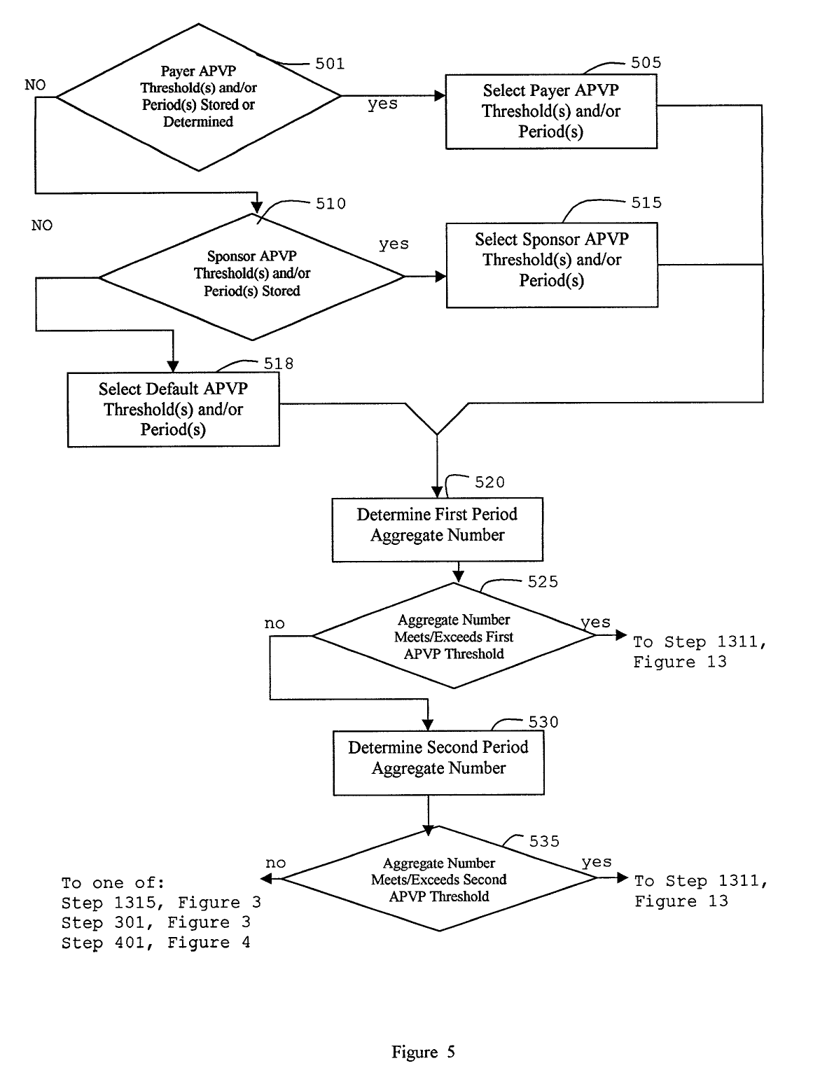

In FIG. 6 SPAP analysis for hold-period determination is depicted. Under SPAP analysis, the period is varied based upon the amount of the payment. One or more payment amount thresholds are set for SPAP analysis. When one payment amount threshold is set, two windows are created. A first window is any amount less than or equal to the payment amount threshold. The second window is any amount greater than the payment amount threshold. Payment amounts falling within the first window are assigned a first hold-period, and payment amounts falling in the second window are assigned a second hold-period, different than the first hold period. It should be understood that the first hold period might be no period. That is, payment to the payee can be made concurrent with the debit from the payer's account. This also applies to APAP and APVP risk analysis, discussed below. When multiple payment amount thresholds are used, at least three windows are created. For example, a first window is any amount less than a first payment amount threshold. A second window is any amount equal to the first payment threshold and less than a second payment amount threshold, the second payment amount threshold greater than the first payment amount threshold. And a third window is any amount equal to or greater than the second payment amount threshold. If more than two payment amount thresholds are used, additional windows are created, as will be understood. Payment amounts falling within a first window will have a first hold-period. Payment amounts falling within a second window will have a second hold-period, and payment amounts falling within a third window will have a third hold-period.

At step 601, the processing agent 130 determines if one or more payer SPAP hold-period thresholds are stored in memory 1170. Or, as above, payer SPAP hold-period thresholds may be determined on a per transaction basis based on information associated with the payment directive.

If no payer SPAP hold-period threshold(s) is/are stored or determined, processing continues with step 610. If one or more payer SPAP hold-period thresholds are stored or determined, processing continues with step 605. At step 605, the window in which the present payment amount falls is determined. Processing continues with step 620.

At step 610, the processing agent 130 determines if one or more sponsor SPAP hold-period thresholds are to be utilized. If so, at step 615, the processing agent 130 determines which window the amount of the present payment request falls. Processing continues with step 620. If no sponsor SPAP hold-period thresholds are stored in memory 1170, processing continues with step 618.

If no payer or sponsor hold-period thresholds are to be utilized, at step 618 the processing agent determines which default SPAP window the amount of the present payment request falls. Processing continues with step 620, wherein the processing agent 130 selects the hold-period corresponding to the determined window.

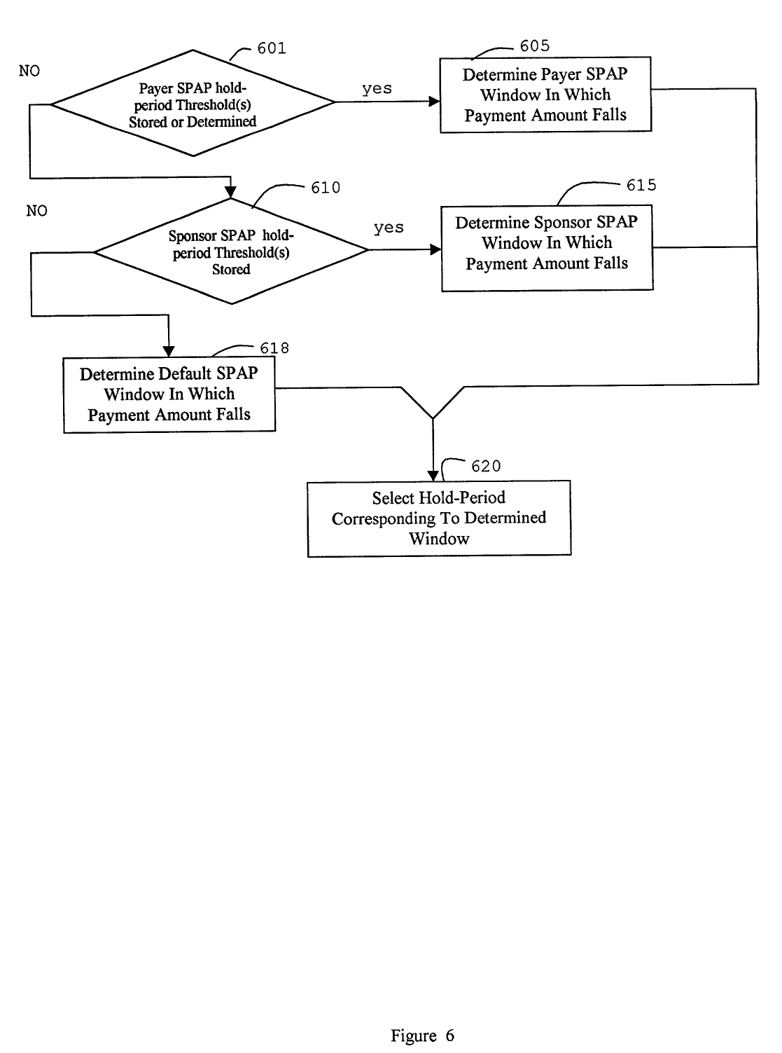

APAP risk analysis may also be used to determine the hold-period. If APAP is to be employed, default criteria are utilized if payer or sponsor criteria are not applicable to the processing. Reference will be made to FIG. 7. At step 701, the processing agent determines if one or more payer APAP hold-period thresholds and/or periods-of-analysis preexist in memory 1170, or alternatively, determines payer APAP hold-period thresholds and/or periods-of-analysis per transaction, as described above.

If the processing agent 130 determines that APAP hold-period criteria is stored, or processes information associated with the payment directive to determine APAP hold-period criteria for the present transaction, at step 705 the window, or windows, in which the aggregate value or values fall is determined. If two or more time periods are to be analyzed, each time period is analyzed to determine the windows in which the aggregate values fall. Operations then continue with step 720.

If payer APAP criteria is not stored in memory 1170, or the processing agent 130 does not determine payer APAP criteria, processing continues with step 710. In this step, the processing agent 130 determines if one or more sponsor APAP hold-period thresholds and/or sponsor periods-of-analysis are to be used, as will be understood from the discussion above. If so, at step 715, the window or windows in which the aggregate value or values fall is determined. Thereinafter, operations continue with step 720. If the processing agent 130 determines that sponsor APAP hold-period criteria is not to be utilized, operations continue with step 718. At step 718, the default window or windows in which the aggregate value or values fall is determined.

At step 720, if one time period has been analyzed in payer, sponsor, or default APAP, the hold-period corresponding to that window is selected. If more than one time period has been analyzed, a hold-period corresponding to each determined window is determined. If the determined time periods are different, preferably the longest time period is selected.

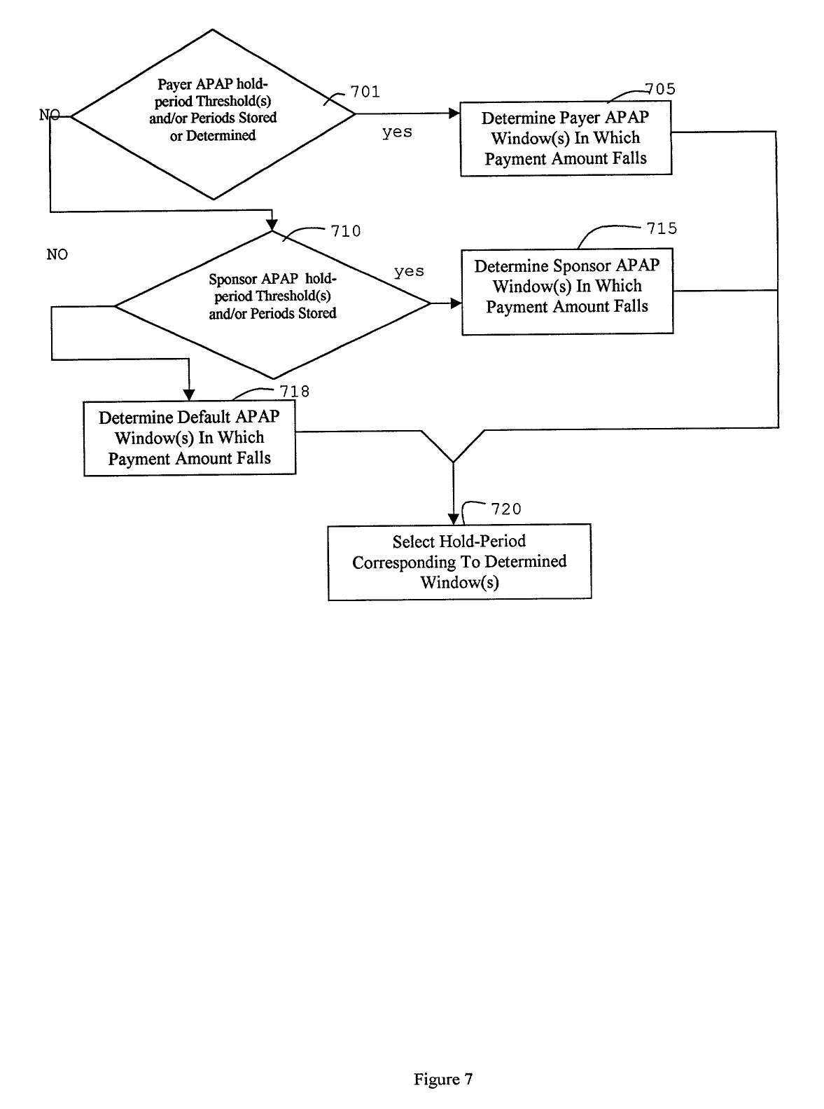

APVP risk analysis may also be used to determine the hold-period. If APVP is to be used, default criteria are utilized if payer or sponsor criteria are not to be used. Like APAP hold-period risk analysis, one or more time periods may be analyzed. The aggregate payment volume, per analyzed period, falls into a window. If two or more periods are analyzed, each period analysis results in determination of a window. A hold-period is selected dependent upon the window or windows in which the aggregate payment volume or volumes fall. If multiple hold-periods result from this analysis, preferably the longest hold-period is selected. Reference will be made to FIG. 8.

At step 801, the processing agent 130 determines if one or more payer APVP hold-period thresholds and/or payer APVP periods-of-analysis are stored in memory 1170. Or alternatively, the processing agent 130 may determine payer APVP hold-period thresholds and/or payer APVP periods-of-analysis on a per-transaction basis, as discussed above. If the processing agent 130 determines that this criteria is stored, or determines the APVP criteria, at step 805, the window or windows in which the aggregate payment volume or volumes fall is determined. Operations continue with step 820.

If the processing agent determines that payer APVP criteria is not stored in memory 1170, or does not determine payer APVP criteria, processing continues with step 810. In this step, the processing agent 130 determines if one or more sponsor APVP hold-period thresholds and/or sponsor APVP periods-of-analysis are to be used. If so, at step 815, the window or windows in which the aggregate payment volume falls is determined. Operations continue with step 820.

If the processing agent 130 determines that sponsor APVP hold-period criteria is not stored in memory, at step 818, the default window or windows in which the aggregate payment volume or volumes fall is determined.

At step 820 a hold-period is selected based upon the determined window or windows. If multiple periods are analyzed, preferably the longest resultant hold-period is selected by the processing agent 130.

It should be understood that when a combination of SPAP, APAP, and APVP hold-period risk analysis is performed by the processing agent 130, and different hold-periods result from different types of processing, the processing agent 130 preferably selects the longer of the determined hold-periods. It should also be understood that, as in the risk analysis to determine acceptance of a payment directive for execution, that all payments executed on behalf of a registered user may be considered, irrespective of the unique identifier contained in the payment directive. That is, the processing agent 130 may identify each payment executed for a registered user based upon each unique identifier associated with that registered user. Also, any payer criteria is preferably the same no matter which unique identifier a particular registered user submits in a payment directive.

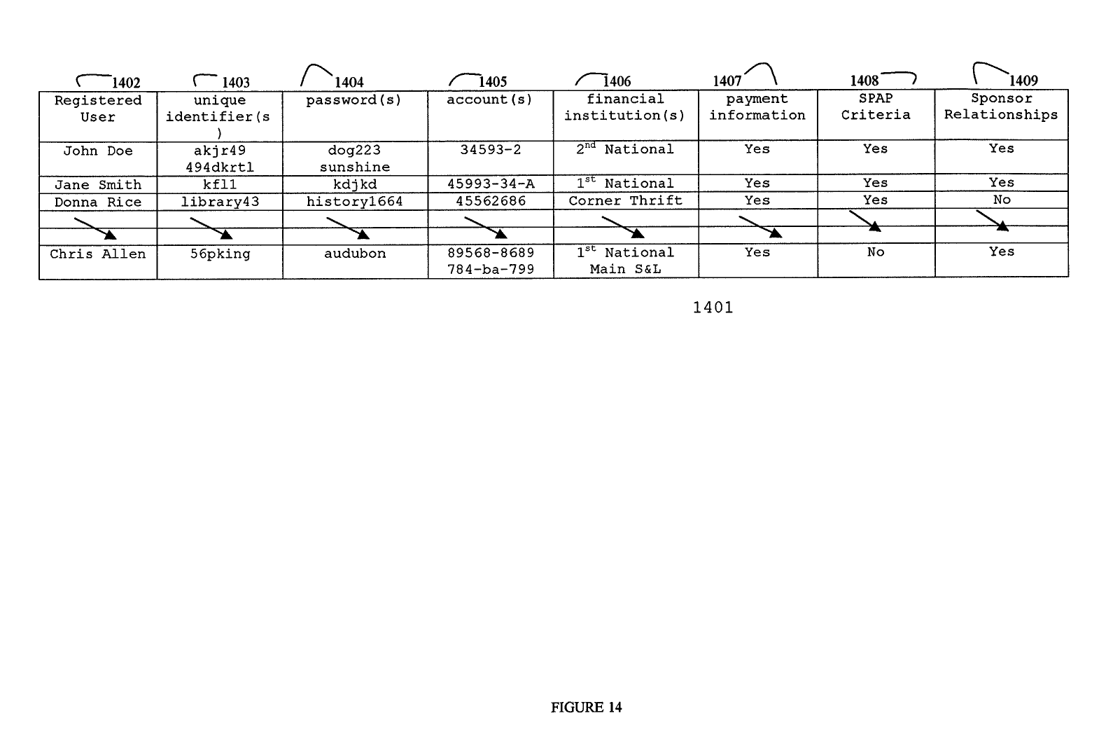

FIG. 14 is a simplified depiction of a database 1401 containing information relating to registered users. This database includes the registered user's name 1402, unique identifier, or identifiers if the user has registered more than one, 1403, password(s) 1404, account number(s) 1405, financial institution information 1406, transaction history 1407, user SPAP criteria 1408, and indication of sponsor relationships 1409, among other information. The processing agent 130 may utilize this database in the risk processing discussed above to identify all past payments, including the time of each payment and its amount, made by the registered user, no matter the unique identifier used when directing a payment.

It will also be recognized by those skilled in the art that, while the invention has been described above in terms of one or more preferred embodiments, it is not limited thereto. Various features and aspects of the above described invention may be used individually or jointly. Further, although the invention has been described in the context of its implementation in a particular environment and for particular purposes, e.g. risk processing, those skilled in the art will recognize that its usefulness is not limited thereto and that the present invention can be beneficially utilized in any number of environments and implementations. Accordingly, the claims set forth below should be construed in view of the full breadth and spirit of the invention as disclosed herein.

We claim:

1. A method for ameliorating financial risk in providing electronic payment services, comprising:
receiving, via a network, a request to execute a payment on behalf of a network user associated with two or more user identifiers, the request including a first user identifier;
processing previous requests executed on behalf of the network user, each previous request including one of the two or more user identifiers, to determine if the request will be accepted for execution; and
if the determination is to accept the request for execution, directing a debit from an account associated with the network user.

2. A method for processing electronic payment requests, comprising:
receiving, via a network, a request to execute a payment on behalf of a network user, the request including a user identifier associated with the network user;
identifying all user identifiers associated with the network user;
processing previously executed payments associated with each identified user identifier to determine if the request will be accepted for execution; and
transmitting, via the network, the determination.

3. The method of claim 2, wherein:
the determination is transmitted to the network user; and
the transmission is a real-time transmission.

4. The method of claim 2, further comprising:
determining a total monetary value of previously executed payments executed in one or more time periods;
determining if the total monetary value of previously executed payments executed in the one or more time periods exceeds one or more threshold values; and
if the determination is the total monetary value of previously executed payments executed in the one or more time periods does exceed one or more threshold values, not accepting the request for execution.

5. The method of claim 4, wherein:
the user identifier included with the request is also associated with a sponsor; and
at least one of the one or more threshold values and the one or more time periods is based upon the identity of the sponsor.

6. The method of claim 4, further comprising:
determining if the total monetary value of previously executed payments in the one or more time periods in combination with an amount of the payment exceeds one or more threshold values; and
if so determined, not accepting the request for execution.

7. The method of claim 2, further comprising:
determining a total number of previously executed payments executed in one or more time periods;
determining if the total number of previously executed payments executed in the one or more time periods exceeds one or more values; and
if the determination is the total number of previously executed payments executed in the one or more time periods does exceed one or more values, not accepting the request for execution.

8. The method of claim 7, wherein:
the user identifier included with the request is also associated with a sponsor; and
at least one of the one or more values and the one or more time periods is based upon the identity of the sponsor.

9. The method of claim 2, wherein the payment is one of (1) a payment of a bill, (2) a gift, (3) a payment for the purchase of goods or services made via the network, and (4) a payment for goods or services purchased from an Internet auction.

10. The method of claim 2, if the determination is to accept the request for execution, further comprising:
directing a debit from an account associated with the network user at a first time; and
directing a credit to a payee at a second time;
wherein the second time is subsequent to the first time; and
wherein a time period between the first time and the second time is a determined time period.

11. The method of claim 10, further comprising:
processing previously executed payments associated with each identified user identifier to determine the time period.

12. The method of claim 10, further comprising:
determining the time period based upon at least one of (1) an amount of the payment, (2) the identity of the network user, (3) an association maintained by the network user, and (4) payments previously executed on behalf of the network user.

13. A method for processing a payment request, comprising:
receiving a request via a network to execute a payment to a payee on behalf of a network user;
determining a time period for crediting the payee subsequent to debiting an account associated with the network user;
directing a debit from the network user account at a first time, the first time beginning the determined time period; and
directing a credit to the payee at a second time, the second time at the end of the determined time period.

14. The method of claim 13, wherein the determined time period is determined based upon at least one of (1) the identity of the network user, (2) an amount of the payment, (3) an association maintained by the network user, and (4) payments previously executed on behalf of the network user.

15. The method of claim 13, wherein the request includes a user identifier associated with the network user, further comprising:
identifying all user identifiers associated with the network user;
processing previously executed payments associated with each identified user identifier to determine the period.

16. The method of claim 15, further comprising:
determining a total monetary value of previously executed payments executed in one or more time periods; and
determining if the total monetary value of previously executed payments executed in the one or more time periods exceeds one or more threshold values to determine the period.

17. The method of claim 16, wherein:
the user identifier included with the request is also associated with a sponsor; and
at least one of the one or more threshold values and the one or more time periods is based upon the identity of the sponsor.

18. The method of claim 16, further comprising:
determining if the total monetary value of previously executed payments in the one or more time periods in combination with an amount of the payment exceeds one or more threshold values to determine the period.

19. The method of claim 15, further comprising:
determining a total number of previously executed payments executed in one or more time periods; and
determining if the total number of previously executed payments executed in the one or more time periods exceeds one or more values to determine the period.

20. The method of claim 19, wherein:
the user identifier included with the request is also associated with a sponsor; and
at least one of the one or more values and the one or more time periods is based upon the identity of the sponsor.

21. A system for processing payment requests, comprising:
a communications port configured to receive and to transmit information via a network;
a memory configured to store a plurality of user identifiers associated with a plurality of network users and information associated with previously executed payments on behalf of the plurality of network users, the information associated with each previously executed payment including a user identifier; and
a processor in communication with the communications port and the memory and configured to (1) receive a request to execute a payment on behalf of one of the plurality of network users, the request including a user identifier associated with the network user, (2) identify all user identifiers associated with the network user stored in the memory, (3) identify previously executed payments associated with each identified user identifier stored in the memory, (4) determine if the request will be accepted for execution based upon the identified previously executed payments, and (5) cause a notice of the determination to be transmitted.

22. The system of claim 21, wherein the processor is further configured to cause the notice to be transmitted to the network user in real-time.23. The system of claim 21, wherein the processor is further configured to (1) determine a total monetary value of previously executed payments in one or more time periods, (2) determine if this total exceeds one or more threshold values, and (3) if the determination is this total does exceed one or more threshold values, determine not to accept the request for execution.

24. The system of claim 23, wherein:
the user identifier included in the request is also associated with a sponsor; and
at least one of the one or more threshold values and the one or more time periods is based upon the identity of the sponsor.

25. The system of claim 23, wherein the processor is further configured to (1) determine if the total monetary value of previously executed payments executed in the one or more time periods in combination with an amount of the payment exceeds one or more threshold values, and (2) if so, determine not to accept the request for execution.

26. The system of claim 21, wherein the processor is further configured to (1) determine a total number of previously executed payments executed in one or more time periods, (2) determine if the total number of previously executed payments executed in the one or more time periods, plus the present request, exceeds one or more values, and (3) if the determination is the total number of previously executed payments executed in the one or more time periods, plus the present request, does exceed one or more values, determine not to accept the request for execution.

27. The system of claim 26, wherein:
the user identifier included in the request is also associated with a sponsor; and
at least one of the at least one values and the one or more time periods is based upon the identity of the sponsor.

28. The system of claim 21, wherein the payment is one of (1) a payment of a bill, (2) a gift, (3) a payment for the purchase of goods or services made via the network, and (4) a payment for goods or services purchased from an Internet auction.

29. The system of claim 21, wherein:
if the processor determines to accept the request for execution, the processor is further configured to (1) direct a debit from an account associated with the network user at a first time, and (2) direct a credit to a payee at a second time;
the second time is subsequent to the first time; and
a time period between the first time and the second time is a determined time period.

30. The system of claim 29, wherein the processor is further configured to determine the time period based upon the identified previously executed payments.

31. The system of claim 29, wherein the processor is further configured to determine the time period based upon at least one of (1) an amount of the payment, (2) the identity of the network user, (3) an association maintained by the network user, and (4) payments previously executed on behalf of the network user.

32. A system for processing a payment request, comprising:
a communications port configured to receive and to transmit information via a network;
a memory configured to store information associated with network users and associated with transactions executed on behalf of network users, each transaction associated with a user identifier; and
a processor in communication with the communications port and the memory and configured to (1) receive a request to execute a payment on behalf of a network user, (2) determine, based upon information stored in the memory, a time period between a debit from an account associated with the network user and a credit a payee, (3) direct a debit from the account associated with the network user at a first time, the first time beginning the determined time period, and (4) direct a credit to the payee at a second time, the second time at the end of the determined time period.

33. The system of claim 32, wherein the payee is also a network user.

34. The system of claim 32, wherein the processor is further configured to determine the period based upon at least one of (1) the identity of the network user, (2) an amount of the payment, (3) an association maintained by the network user, and (4) payments previously executed on behalf of the network user.

35. The system of claim 32, wherein:
the request includes a user identifier associated with the network user;
the processor is further configured to (1) identify all user identifiers associated with the network user, (2) identify all transactions associated with the identified user identifiers, and (3) determine the period based upon the identified transactions.

36. The system of claim 35, wherein the processor is further configured to:
determine a total monetary value of the identified transactions executed in one or more time periods; and
determine if the total monetary value of the identified transactions executed in the one or more time periods, plus a monetary value of the request, exceeds one or more threshold values to determine the period.

37. The system of claim 36, wherein:
the user identifier included with the request is also associated with a sponsor; and
at least one of the one or more threshold values and the one or more time period is based upon the identity of the sponsor.

38. The system of claim 35, wherein the processor is further configured to:
determine a total number of identified transactions executed in one or more time periods; and
determine if the total number of identified transactions executed in the one or more time periods, plus the present request, exceeds one or more threshold values to determine the period.

39. The system of claim 38, wherein:
the user identifier included with the request is also associated with a sponsor; and
at least one of the one or more threshold values and the one or more time periods is based upon the identity of the sponsor.

40. A system for ameliorating financial risk in providing electronic payment services, comprising:
a communications port configured to receive and to transmit information via a network;
a memory configured to store information associated with previous payment requests executed on behalf of a network user; and
a processor in communication with the communications port and the memory configured to (1) receive a request to execute a payment on behalf of a network user associated with two or more user identifiers, the request including a first user identifier, (2) processing the information associated with previous payment requests stored in the memory, each previous payment request stored in the memory including one of the two or more user identifiers, to determine if the request will be accepted for execution, and (3) if the determination is to accept the request for execution, to direct a debit from an account associated with the network user.
